(19) United States
(12) Patent Application Publication
(10) Pub. No.: US 2024/0125813 A1
(43) Pub. Date: Apr. 18, 2024

(54) INERTIAL SENSOR UNIT

(71) Applicant: SEIKO EPSON CORPORATION, Tokyo (JP)

(72) Inventors: Ryuji Kihara, Matsumoto-shi (JP); Mikimoto Jin, Ina-shi (JP); Ryoichi Nozawa, Tatsuno-machi (JP)

(21) Appl. No.: 18/486,359

(22) Filed: Oct. 13, 2023

(30) Foreign Application Priority Data
Oct. 17, 2022 (JP) 2022-166058

(51) Int. Cl. G01P 15/08; G01P 3/02; G01P 15/18

(52) U.S. Cl. CPC G01P 15/08; G01P 3/02; G01P 15/18

(57) ABSTRACT

An inertial sensor unit includes a first board on which a plurality of inertial sensor modules are mounted, and a second board on which a processing circuit configured to process signals from a plurality of inertial sensor modules is mounted.

The present application is based on, and claims priority from JP Application Serial Number 2022-166058, filed Oct. 17, 2022, the disclosure of which is hereby incorporated by reference herein in its entirety.

### BACKGROUND

### 1. Technical Field

The present disclosure relates to an inertial sensor unit.

### 2. Related Art

JP-A-2018-9908 discloses a sensor device in which a plurality of inertial sensor modules (for example, inertial measurement unit (IMU)) and a processing circuit such as a microcomputer are mounted on the same board.

In the technique disclosed in JP-A-2018-9908, there is a problem that a planar size is increased since the inertial sensor modules and the processing circuit are mounted on the same board. In particular, in a multi-IMU using a plurality of inertial sensor modules, since characteristics are stabilized as the number of the IMUs increases, it is desirable to increase the number of the IMUs as many as possible. Accordingly, a size of a board on which the IMUs are mounted is increased, and more pieces of signal processing are required, which leads to an increase in a size of the processing circuit.

### SUMMARY

An inertial sensor unit includes a first board on which a plurality of inertial sensor modules are mounted, and a second board on which a processing circuit configured to process signals from the plurality of inertial sensor modules is mounted.

### BRIEF DESCRIPTION OF THE DRAWINGS

FIG. 1 is a perspective view showing a configuration of an inertial sensor unit that accommodates sensor modules.

FIG. 2 is a plan view showing a configuration of the inertial sensor unit.

FIG. 3 is a perspective view showing a configuration of the sensor modules.

FIG. 4 is an exploded perspective view showing a configuration of the sensor modules.

FIG. 5 is a perspective view showing a configuration of a conduction portion between a first board and a second board.

FIG. 6 is a block diagram showing a configuration of the inertial sensor unit.

FIG. 7 is an exploded perspective view showing a configuration of inertial sensor modules.

FIG. 8 is a plan view showing a configuration of a circuit board.

FIG. 9 is a plan view showing a configuration of the circuit board.

FIG. 10 is a cross-sectional view showing a configuration of an inertial sensor unit according to a modification.

FIG. 11 is a cross-sectional view showing a configuration of an inertial sensor unit according to a modification.

FIG. 12 is a cross-sectional view showing a configuration of an inertial sensor unit according to a modification.

FIG. 13 is a perspective view showing a configuration of an inertial sensor unit according to a modification.

### DESCRIPTION OF EMBODIMENTS

In the following drawings, three axes orthogonal to one another are defined as an X axis, a Y axis, and a Z axis. A direction along the X axis is defined as an “X direction”, a direction along the Y axis is defined as a “Y direction”, a direction along the Z axis is defined as a “Z direction”, a direction of an arrow is defined as a + direction, and a direction opposite to the + direction is defined as a − direction. A+Z direction may be referred to as “upper” or “upper side”, a −Z direction may be referred to as “lower” or “lower side”, and a view from the +Z direction and the −Z direction is also referred to as a plan view or planar. A surface on a +Z direction side is referred to as an upper surface and a surface on a −Z direction side opposite to the +Z direction side is referred to as a lower surface.

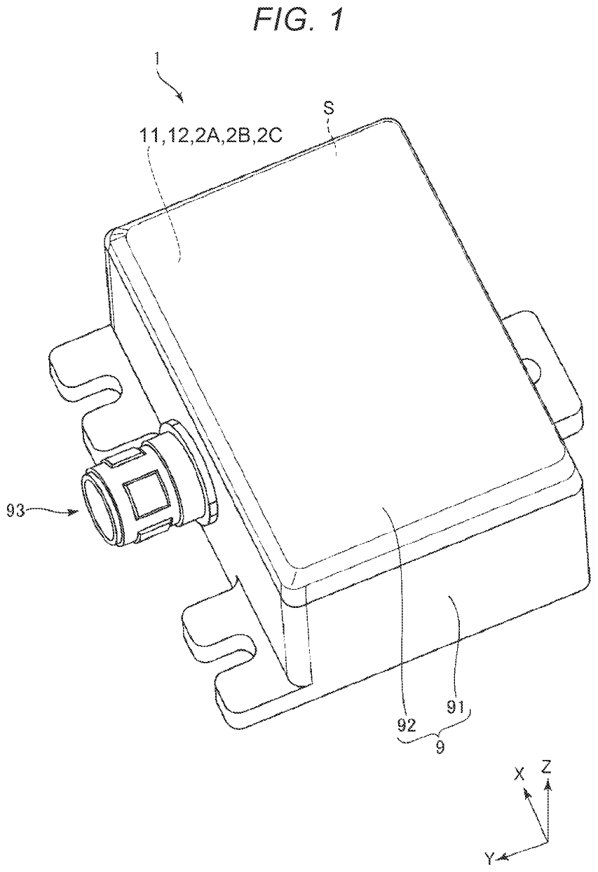

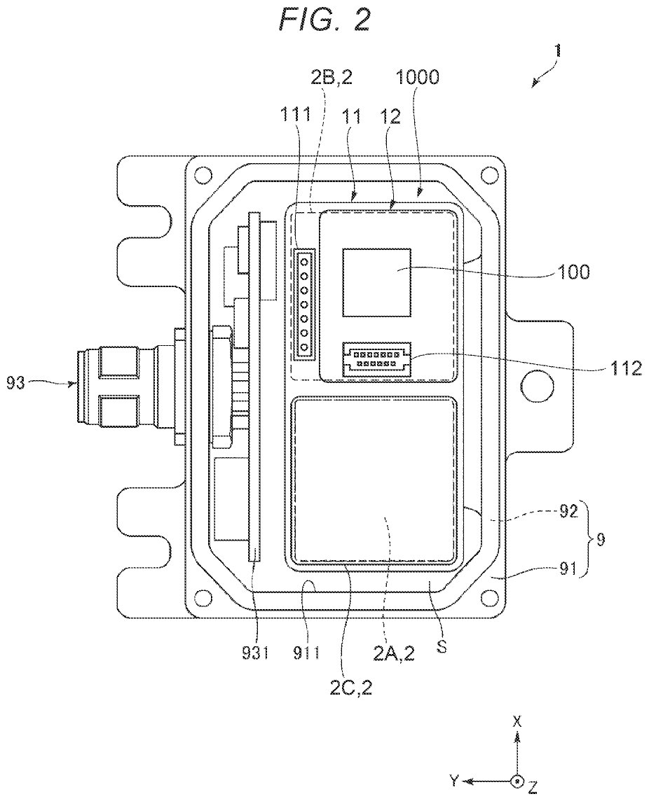

First, a configuration of an inertial sensor unit 1 will be described with reference to FIGS. 1 and 2.

As shown in FIG. 1, the inertial sensor unit 1 is an inertial measurement device that detects a posture and a behavior of a vehicle such as an automated vehicle, an agricultural machine, a construction machine, a robot, and a drone. The inertial sensor unit 1 is a composite sensor unit including an angular velocity sensor 26 that detects angular velocities of three axes and an acceleration sensor 27 that detects accelerations of the three axes which will be described later. Accordingly, the inertial sensor unit 1 has high convenience.

As shown in FIGS. 1 and 2, the inertial sensor unit 1 includes a container 9 serving as a case and a sensor unit 1000 accommodated in the container 9. The sensor unit 1000 includes a first board 11, a first inertial sensor module 2A, a second inertial sensor module 2B, and a third inertial sensor module 2C that are mounted on the first board 11, and a second board 12 disposed in a manner of overlapping the first board 11 in a plan view. Although three sensor modules are provided in the embodiment as described above, two sensor modules or four or more sensor modules may be provided.

The container 9 includes a base 91 having a recessed portion 911 that is opened on an upper surface, and a lid 92 fixed to the base 91 so as to close an opening of the recessed portion 911. An accommodation space S is formed in the container 9. In the accommodation space S, the three inertial sensor modules 2A, 2B, and 2C are accommodated in a state of being mounted on the first board 11. Accordingly, the inertial sensor modules 2A, 2B, and 2C can be protected from dust, dirt, moisture, ultraviolet rays, impact, and the like.

The base 91 and the lid 92 are made of, for example, aluminum (Al). Accordingly, the container 9 is sufficiently hard. A material of the base 91 and the lid 92 is not limited to aluminum, and for example, a metal material such as an aluminum alloy, zinc, and stainless steel, various ceramics, various resin materials, and a composite material of a metal material and a resin material may be used. The base 91 and the lid 92 may be made of different materials.

A connector 93 is attached to a side wall of the base 91. The connector 93 has a function of electrically connecting an inner side to an outer side of the container 9. As shown in FIG. 2, the inertial sensor unit 1 includes a board 931 including an interface circuit electrically coupled to the connector 93.

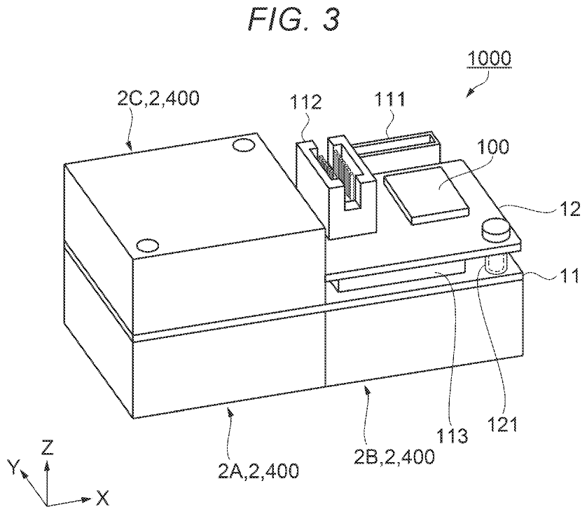

Next, the configuration of the sensor unit 1000 will be specifically described with reference to FIGS. 3 to 5.

As shown in FIG. 3, the sensor unit 1000 includes the first board 11 and the second board 12 disposed at a predetermined interval from the first board 11 in a manner of overlapping the first board 11. The first board 11 and the second board 12 are circuit boards, and although not shown, predetermined circuits and interconnects are formed at the boards.

The first board 11 also functions as a support board, and supports parts such as the first inertial sensor module 2A, the second inertial sensor module 2B, the third inertial sensor module 2C, and the second board 12. The first board 11 is fixed to the base 91 by, for example, screws. A method for fixing the first board 11 to the container 9 is not particularly limited.

The first inertial sensor module 2A and the second inertial sensor module 2B are arranged side by side along an X-axis direction on a lower surface of the first board 11. The third inertial sensor module 2C is disposed on an upper surface of the first board 11 in a manner of overlapping the first inertial sensor module 2A in a plan view. A first connector 111 electrically coupled to the board 931 is disposed on the first board 11.

Since the second inertial sensor module 2B and the third inertial sensor module 2C have the same configuration as the first inertial sensor module 2A, hereinafter the first inertial sensor module 2A, the second inertial sensor module 2B, and the third inertial sensor module 2C will be described as an inertial sensor module 2. The present disclosure is not limited thereto, and at least one of the inertial sensor modules 2A, 2B, and 2C may have a configuration different from configurations of the other inertial sensor modules.

The inertial sensor module 2 includes inertial sensor devices 26 and 27, and a metal case 400 in which the inertial sensor devices 26 and 27 are packaged.

The inertial sensor devices 26 and 27 are, for example, the angular velocity sensor 26 and the acceleration sensor 27 which will be described later. The angular velocity sensor 26 can detect angular velocities of three axes, and the acceleration sensor 27 can detect accelerations of three axes. Accordingly, the inertial sensor module 2 detects the angular velocities of three axes and the accelerations of three axes.

The metal case 400 is made of, for example, aluminum (Al). Accordingly, the metal case 400 is sufficiently hard. A material of the metal case 400 is not limited to aluminum, and for example, a metal material such as an aluminum alloy, zinc, and stainless steel, various ceramics, various resin materials, and a composite material of a metal material and a resin material may be used.

Since the inertial sensor devices 26 and 27 are packaged in the metal case 400 in this manner, for example, the inertial sensor devices 26 and 27 are less likely to be affected by external impact or electromagnetic waves. Further, since the inertial sensor devices 26 and 27 are packaged in the metal case 400, the inertial sensor devices 26 and 27 are less likely to be affected by fine vibration.

The second board 12 is disposed on the first board 11 in a manner of overlapping the second inertial sensor module 2B in a plan view. The second board 12 is disposed at a predetermined interval from the first board 11 by using, for example, a spacer 121. A processing circuit 100 and a second connector 112 used for operation check and the like are disposed on the second board 12.

The processing circuit 100 processes a signal from the inertial sensor module 2. The processing circuit 100 controls driving of parts of the inertial sensor unit 1, particularly, controls driving of the first inertial sensor module 2A, the second inertial sensor module 2B, and the third inertial sensor module 2C. The processing circuit 100 is electrically coupled to the first connector 111. The first connector 111 is electrically coupled to an interface circuit of the board 931 via an interconnect (not shown). The processing circuit 100 is, for example, a micro controller unit (MCU), incorporates a storage unit including a nonvolatile memory, an A/D converter, and the like, and controls parts of the inertial sensor unit 1. The processing circuit 100 includes a calculation unit that performs calculation using measurement values of the inertial sensor module 2.

By disposing the first board 11 and the second board 12 in this manner, spaces on the upper surface and the lower surface of the first board 11 can be effectively used without waste. Accordingly, it is possible to reduce sizes of the first board 11 and the second board 12 and reduce a size of the inertial sensor unit 1 accordingly.

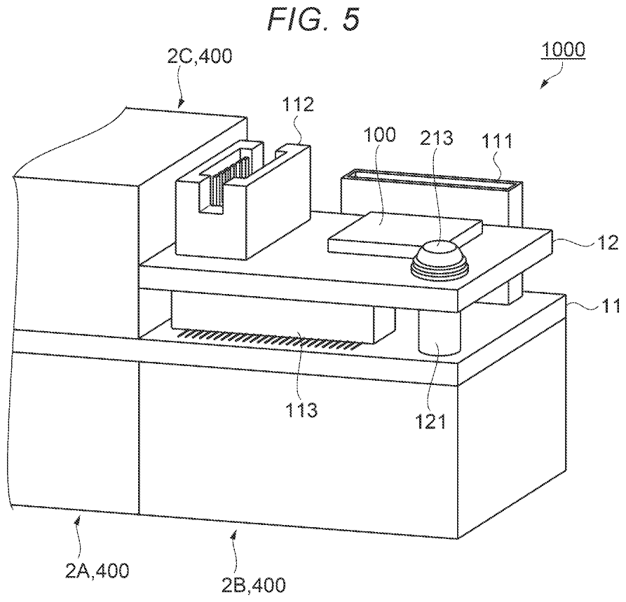

As shown in FIG. 5, a third connector 113 for transmitting and receiving data between the first board 11 and the second board 12 is disposed on the first board 11 and the second board 12.

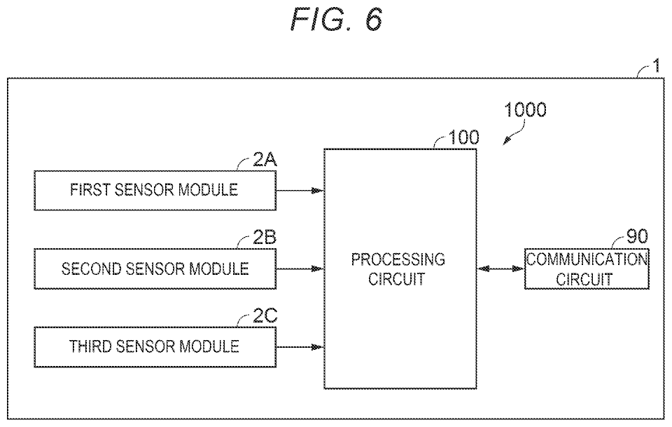

Next, the configuration of the sensor unit 1000 will be described with reference to FIG. 6.

As shown in FIG. 6, the sensor unit 1000 includes the first inertial sensor module 2A, the second inertial sensor module 2B, the third inertial sensor module 2C, the processing circuit 100, and a communication circuit 90. The communication circuit 90 is mounted on, for example, the board 931. The board 931 outputs, for example, inertial data calculated by the processing circuit 100 to another device.

The processing circuit 100 generates synthesized inertial data based on the measurement values obtained from the first inertial sensor module 2A, the second inertial sensor module 2B, and the third inertial sensor module 2C. By using the plurality of inertial sensor modules, that is, 2A, 2B, and 2C, noises of sensors can be reduced, and stable output can be obtained. For example, the processing circuit 100 calculates an average value of inertial data as measurement values obtained from the first inertial sensor module 2A, the second inertial sensor module 2B, and the third inertial sensor module 2C. The calculated inertial data may be an angular velocity or an acceleration. The processing circuit 100 may calculate other kinds of inertial data using the calculated acceleration and angular velocity. The other kinds of inertial data include, for example, a posture and an orientation of an object, and a magnitude of vibration, a movement, impact, and the like.

As described above, since a plurality of the inertial sensor devices 26 and 27 are mounted on the first board 11, the processing circuit 100 is mounted on the second board 12, and the first board 11 and the second board 12 are disposed in a manner of overlapping each other, it is possible to reduce a size as compared with a case where the plurality of inertial sensor devices 26 and 27 and the processing circuit 100 are mounted on the same board. Further, since the first board 11 and the second board 12 are separated from each other, for example, it is possible to prevent heat or vibration of the processing circuit 100 from affecting the inertial sensor devices 26 and 27.

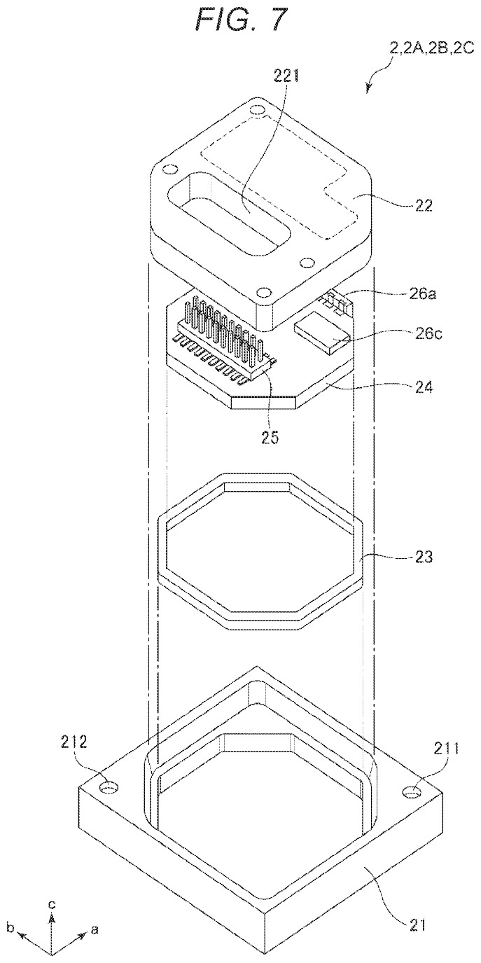

Next, configurations of the inertial sensor modules 2A, 2B, and 2C will be described with reference to FIG. 7. Since the inertial sensor modules 2A, 2B, and 2C have the same configuration, the inertial sensor module 2 will be described below.

In the description of the inertial sensor module 2, FIGS. 7 to 9 show an a axis, a b axis, and a c axis. A direction along the a axis is also referred to as an a-axis direction, a direction along the b axis is also referred to as a b-axis direction, and a direction along the c axis is also referred to as a c-axis direction. An arrow side of each axis is also referred to a “positive side”, and an opposite side is also referred to a “negative side”. The a axis, the b axis, and the c axis are axes set for the inertial sensor module 2, and are axes different from the X axis, the Y axis, and the Z axis which are axes set for the inertial sensor unit 1.

As shown in FIG. 7, the inertial sensor module 2 includes an outer case 21 and an inner case 22. The inertial sensor module 2 is configured such that the inner case 22 is inserted into the outer case 21, and the inner case 22 and the outer case 21 are joined by a joining member 23.

An outer shape of the inertial sensor module 2, that is, the outer case 21 has a substantially rectangular shape, particularly a square, in a plan view from the c-axis direction. A screw hole 211 is provided in one of a pair of opposing corners of the outer case 21, and a screw hole 212 is provided in the other corner. The inertial sensor module 2 is fixed to the first board 11 by screws using the screw holes 211 and 212. The outer shape of the inertial sensor module 2 and an arrangement and the number of the screw holes 211 and 212 are not particularly limited. A method for fixing the inertial sensor module 2 is not particularly limited.

The inertial sensor module 2 includes a circuit board 24 accommodated between the outer case 21 and the inner case 22. The circuit board 24 is supported by the inner case 22.

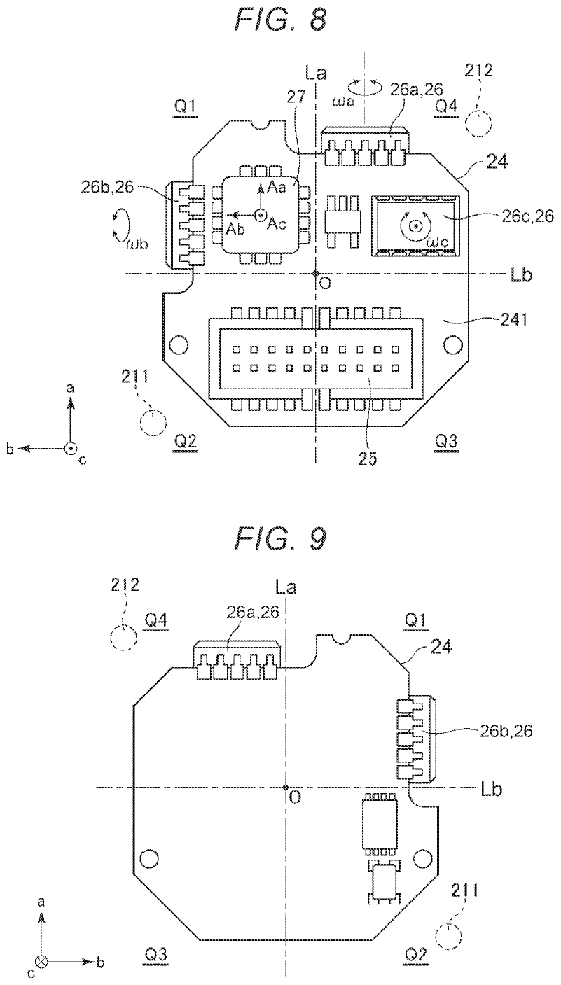

A module connector 25 that is electrically coupled to the first board 11, an angular velocity sensor 26a that detects an angular velocity coa around the a axis, an angular velocity sensor 26b that detects an angular velocity cob around the b axis, an angular velocity sensor 26c that detects an angular velocity coc around the c axis, and the acceleration sensor 27 that detects an acceleration in each axial direction of the a axis, the b axis, and the c axis are mounted on the circuit board 24 (see FIGS. 7 and 8). In general, signals output from the inertial sensor devices 26 and 27 have misalignments relative to a plurality of detection axes due to a misalignment or the like during assembly. Therefore, the inertial sensor module 2 may perform error alignment correction for applying a predetermined correction coefficient such as a rotation matrix to the signals of the inertial sensor devices 26 and 27. At this time, signals of the a axis, the b axis, and the c axis which are detection axes may be converted into signals of three axes orthogonal to one another. Here, three axes orthogonal to one another may be set for an outer shape of the inertial sensor unit 1.

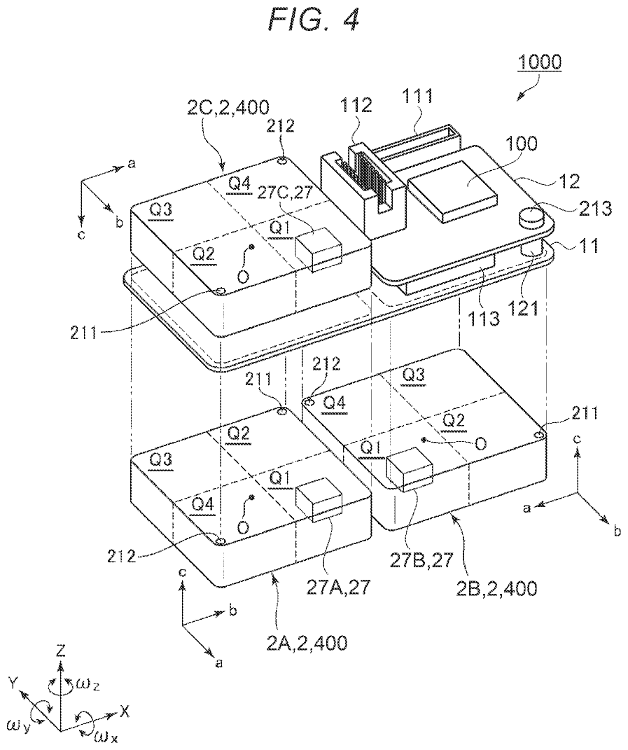

As shown in FIG. 4, for the X axis, the Y axis, and the Z axis which are axes set for the inertial sensor unit 1, the angular velocity sensor 26 is also referred to as an X-axis angular velocity sensor that detects an angular velocity cox around the X axis, a Y-axis angular velocity sensor that detects an angular velocity coy around the Y axis, and a Z-axis angular velocity sensor that detects an angular velocity coz around the Z axis.

The angular velocity sensors 26a, 26b, and 26c and the acceleration sensor 27 are electrically coupled to the module connector 25. The module connector 25 is exposed from an opening 221 provided in the inner case 22, and can be electrically coupled to the first board 11.

A connector (not shown) connected to the module connector 25 provided in the first inertial sensor module 2A is disposed in a portion of the first board 11 where the first inertial sensor module 2A is disposed. The connector (not shown) is electrically coupled to the processing circuit 100 disposed on the second board 12 via the third connector 113 (see FIG. 5) serving as a conduction portion that conducts the first board 11 and the second board 12. In this manner, the inertial sensor modules 2A, 2B, and 2C are electrically coupled to the processing circuit 100 disposed on the second board 12.

Next, a configuration of the circuit board 24 will be described with reference to FIGS. 8 and 9. Hereinafter, in a plan view from the c-axis direction, four quadrants defined by a virtual line La intersecting an center O of the inertial sensor module 2 and extending in the a-axis direction and a virtual line Lb intersecting the center O of the inertial sensor module 2 and extending in the b-axis direction are referred to as a first quadrant Q1, a second quadrant Q2, a third quadrant Q3, and a fourth quadrant Q4.

The first quadrant Q1 is located on a positive side in the a-axis direction and a positive side in the b-axis direction relative to the center O. The second quadrant Q2 is located on a negative side in the a-axis direction and the positive side in the b-axis direction relative to the center O. The third quadrant Q3 is located on the negative side in the a-axis direction and a negative side in the b-axis direction relative to the center O. The fourth quadrant Q4 is located on the positive side in the a-axis direction and the negative side in the b-axis direction relative to the center O.

The module connector 25 is disposed on an upper surface 241 of the circuit board 24, and is located in the second quadrant Q2 and the third quadrant Q3. The angular velocity sensor 26a is disposed on a side surface of the circuit board 24, and is located in the fourth quadrant Q4. The angular velocity sensor 26b is disposed on a side surface of the circuit board 24, and is located in the first quadrant Q1. The angular velocity sensor 26c is disposed on the upper surface 241 of the circuit board 24, and is located in the fourth quadrant Q4.

The acceleration sensor 27 is disposed on the upper surface 241 of the circuit board 24, and is located in the first quadrant Q1. The screw hole 211 is located in the second quadrant Q2. The screw hole 212 is located in the fourth quadrant Q4.

Next, returning to FIG. 4, an arrangement of the first inertial sensor module 2A, the second inertial sensor module 2B, and the third inertial sensor module 2C will be described. Hereinafter, for the convenience of description, the acceleration sensor 27 provided in the first inertial sensor module 2A is also referred to as a first acceleration sensor 27A, the acceleration sensor 27 provided in the second inertial sensor module 2B is also referred to as a second acceleration sensor 27B, and the acceleration sensor 27 provided in the third inertial sensor module 2C is also referred to as a third acceleration sensor 27C.

The first inertial sensor module 2A is disposed such that the a axis coincides with the Y axis, the b axis coincides with the X axis, and the c axis coincides with the Z axis, and the positive side in the a-axis direction faces the negative side in the Y-axis direction, the positive side in the b-axis direction faces the positive side in the X-axis direction, and a positive side in the c-axis direction faces a positive side in the Z-axis direction.

The second inertial sensor module 2B is disposed such that the a axis coincides with the X axis, the b axis coincides with the Y axis, and the c axis coincides with the Z axis, and a positive side in the a-axis direction faces a negative side in the X-axis direction, the positive side in the b-axis direction faces a negative side in the Y-axis direction, and the positive side in the c-axis direction faces the positive side in the Z-axis direction. That is, the second inertial sensor module 2B is in a posture rotated by 90° around the Z axis relative to the first inertial sensor module 2A.

The third inertial sensor module 2C is disposed such that the a axis coincides with the X axis, the b axis coincides with the Y axis, and the c axis coincides with the Z axis, and a positive side in the a-axis direction faces a positive side in the X-axis direction, the positive side in the b-axis direction faces a negative side in the Y-axis direction, and a positive side in the c-axis direction faces a negative side in the Z-axis direction. That is, the third inertial sensor module 2C is rotated by 180° around the X axis and is further rotated by 90° around the Z axis relative to the first inertial sensor module 2A.

That is, in the example shown in FIG. 4, the first acceleration sensor 27A of the first inertial sensor module 2A and the third acceleration sensor 27C of the third inertial sensor module 2C are disposed in a manner of overlapping each other when viewed from a direction along the Z axis. The first acceleration sensor 27A of the first inertial sensor module 2A and the second acceleration sensor 27B of the second inertial sensor module 2B are disposed in a manner of overlapping each other when viewed from a direction along the X axis. Accordingly, it is possible to reduce a difference in accelerations received by the first acceleration sensor 27A, the second acceleration sensor 27B, and the third acceleration sensor 27C.

Although a signal from the first inertial sensor module 2A corresponds to a predetermined coordinate axis, the signal from the first inertial sensor module 2A may be converted to coincide with a coordinate axis of another inertial sensor module 2. The conversion of the signal may be performed for all of the first inertial sensor module 2A, the second inertial sensor module 2B, and the third inertial sensor module 2C, or may be performed for some of the first inertial sensor module 2A, the second inertial sensor module 2B, and the third inertial sensor module 2C.

As described above, the inertial sensor unit 1 according to the embodiment includes the first board 11 on which the plurality of inertial sensor modules 2 are mounted, and the second board 12 on which the processing circuit 100 configured to process signals from the plurality of inertial sensor modules 2 is mounted.

According to this configuration, since the plurality of inertial sensor modules 2 are mounted on the first board 11, and the processing circuit 100 is mounted on the second board 12, a size can be reduced corresponding to an arrangement of the boards as compared with a case where the plurality of inertial sensor modules 2 and the processing circuit 100 are mounted on the same board. Further, since the first board 11 and the second board 12 are separated from each other, for example, it is possible to prevent heat or vibration of the processing circuit 100 from affecting the inertial sensor devices 26 and 27.

In the inertial sensor unit 1 according to the embodiment, the first board 11 and the second board 12 are preferably disposed in a manner of overlapping each other. According to this configuration, since the first board 11 and the second board 12 are disposed in the manner of overlapping each other, a planar size can be reduced as compared with a case where the first board 11 and the second board 12 are arranged side by side in a planar manner.

The inertial sensor unit 1 according to the embodiment preferably includes the spacer 121 between the first board 11 and the second board 12. According to this configuration, since the spacer 121 is provided between the first board 11 and the second board 12, an interval between the first board 11 and the second board 12 can be a desired interval by adjusting a thickness of the spacer 121. Accordingly, it is possible to prevent interference between components arranged on the boards 11 and 12.

In the inertial sensor unit 1 according to the embodiment, the plurality of inertial sensor modules 2 are preferably packaged in the metal case 400. According to this configuration, since the inertial sensor devices 26 and 27 are packaged in the metal case 400, for example, the inertial sensor devices 26 and 27 are less likely to be affected by external impact or electromagnetic waves. Since the inertial sensor devices 26 and 27 are packaged in the metal case 400, the inertial sensor devices 26 and 27 are less likely to be affected by fine vibration.

In the inertial sensor unit 1 according to the embodiment, the plurality of inertial sensor modules 2 preferably include an X-axis angular velocity sensor, a Y-axis angular velocity sensor, and a Z-axis angular velocity sensor. According to this configuration, since the angular velocity sensors 26 is provided for each axis, it is possible to detect angular velocities of three axes. Accordingly, the inertial sensor unit 1 can calculate and output not only an angular velocity but also a posture, an orientation, the magnitude of a movement, and the like of an object.

In the inertial sensor unit 1 according to the embodiment, the plurality of inertial sensor modules 2 preferably include the acceleration sensor 27. According to this configuration, since the acceleration sensor 27 is provided, an acceleration can be detected. Accordingly, the inertial sensor unit 1 can calculate and output not only an acceleration but also a magnitude of gravity, a movement, vibration, impact, and the like.

Hereinafter, modifications of the above-described embodiment will be described.

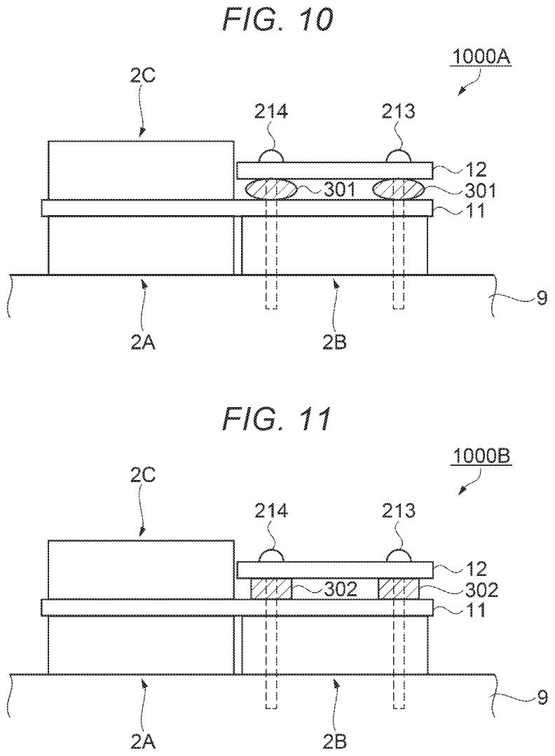

Although the inertial sensor unit 1 includes the sensor unit 1000 as described above, the present disclosure is not limited thereto, and for example, the inertial sensor unit 1 may have a configuration shown in FIG. 10. FIG. 10 is a cross-sectional view showing a configuration of a sensor unit 1000A according to a modification.

As shown in FIG. 10, in the sensor unit 1000A, vibration-proof members 301 that are less likely to transmit vibration are disposed between the first board 11 and the second board 12. Specifically, the vibration-proof members 301 are disposed between the first board 11 and the second board 12 around screws 213 and 214 that fix the first board 11 and the second board 12. The present disclosure is not limited to the vibration-proof member 301, and gel may be used.

As described above, the sensor unit 1000A according to the modification preferably includes the vibration-proof members 301 or gel between the first board 11 and the second board 12. According to this configuration, since the vibration-proof members 301 or gel are provided, for example, it is possible to prevent vibration at the second board 12 side from being transmitted to the first board 11, and it is possible to prevent deterioration of sensor characteristics.

Although the inertial sensor unit 1 includes the sensor unit 1000 as described above, the present disclosure is not limited thereto, and for example, the inertial sensor unit 1 may have a configuration shown in FIG. 11. FIG. 11 is a cross-sectional view showing a configuration of a sensor unit 1000B according to a modification.

As shown in FIG. 11, in the sensor unit 1000B, heat insulating members 302 that are less likely to transfer heat are disposed between the first board 11 and the second board 12. Specifically, the heat insulating members 302 are disposed between the first board 11 and the second board 12 around the screws 213 and 214 that fix the first board 11 and the second board 12. The heat insulating members 302 are not limited to be disposed around the screws 213 and 214, and may be disposed at portions where the first board 11 and the second board 12 are coupled.

As described above, the sensor unit 1000B according to the modification preferably includes the heat insulating members 302 between the first board 11 and the second board 12. According to this configuration, since the heat insulating members 302 are provided, for example, it is possible to prevent heat generated at the second board 12 side from being transferred to the first board 11, and it is possible to prevent deterioration of sensor characteristics.

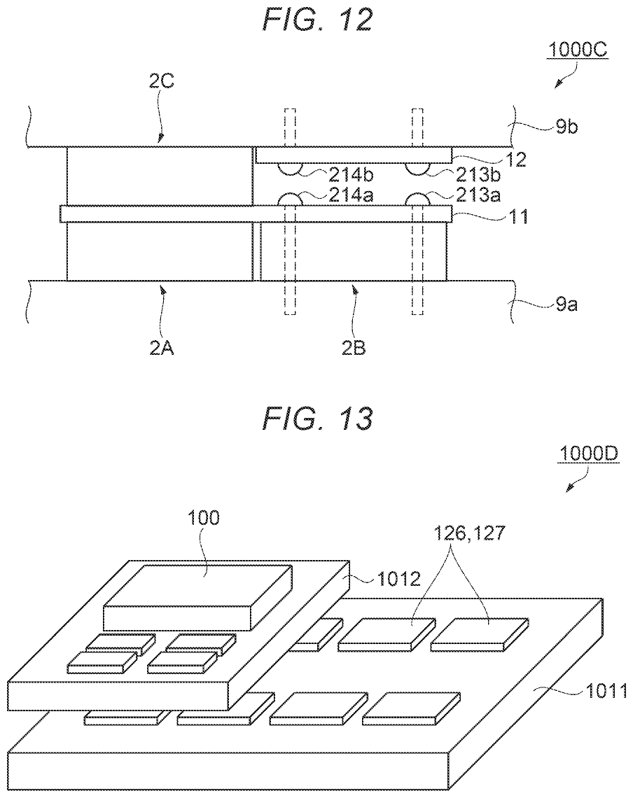

Although the inertial sensor unit 1 includes the sensor unit 1000 as described above, the present disclosure is not limited thereto, and for example, the inertial sensor unit 1 may have a configuration shown in FIG. 12. FIG. 12 is a cross-sectional view showing a configuration of a sensor unit 1000C according to a modification.

As shown in FIG. 12, in the sensor unit 1000C, the first board 11 is fixed to a bottom portion 9a using screws 213a and 214a, and the bottom portion 9a is a first surface of the container 9 serving as a case. On the other hand, the second board 12 is fixed to an upper portion 9b using screws 213b and 214b, and the upper portion 9b is a second surface of the container 9.

As described above, the sensor unit 1000C according to the modification preferably includes the container 9 serving as a case for accommodating the first board 11 and the second board 12, the first board 11 is disposed on the bottom portion 9a of the container 9, and the second board 12 is disposed on the upper portion 9b facing the bottom portion 9a. According to this configuration, since the first board 11 and the second board 12 are separated from each other, for example, heat or vibration generated in the second board 12 can be prevented from affecting the inertial sensor devices 26 and 27.

As shown in FIG. 13, in a sensor unit 1000D, a plurality of inertial sensor devices 126 and 127 may be disposed on a first board 1011, and the processing circuit 100 may be disposed on a second board 1012. Specifically, the first board 1011 and the second board 1012 are fixed to the container 9 at a predetermined interval by screws (not shown) as described above. The first board 1011 and the second board 1012 are electrically coupled to each other using the connector described above, a flexible board, or the like.

What is claimed is:

1. An inertial sensor unit comprising:
a first board on which a plurality of inertial sensor modules are mounted; and
a second board on which a processing circuit configured to process signals from a plurality of inertial sensor modules is mounted.

2. The inertial sensor unit according to claim 1, wherein
the first board and the second board are disposed in a manner of overlapping each other.

3. The inertial sensor unit according to claim 1, wherein
a spacer is provided between the first board and the second board.

4. The inertial sensor unit according to claim 1, wherein
a vibration-proof member or gel is provided between the first board and the second board.

5. The inertial sensor unit according to claim 1, wherein
a heat insulating member is provided between the first board and the second board.

6. The inertial sensor unit according to claim 1, further comprising:
a case that accommodates the first board and the second board, wherein
the first board is disposed on a first surface of the case, and
the second board is disposed on a second surface facing the first surface.

7. The inertial sensor unit according to claim 6, wherein
the plurality of inertial sensor modules are packaged in a metal case.

8. The inertial sensor unit according to claim 1, wherein
the plurality of inertial sensor modules include an X-axis angular velocity sensor, a Y-axis angular velocity sensor, and a Z-axis angular velocity sensor.

9. The inertial sensor unit according to claim 1, wherein
the plurality of inertial sensor modules include an acceleration sensor.
